(19) United States
(12) Patent Application Publication
(10) Pub. No.: US 2016/0082667 A1
(43) Pub. Date: Mar. 24, 2016

(54) Wellbore Logging Tool Design Customization and Fabrication Using 3D Printing and Physics Modeling

(71) Applicant: HALLIBURTON ENERGY SERVICES INC., Houston, TX (US)

(72) Inventor: BURKAY DONDERICI, Houston, TX (US)

(21) Appl. No.: 14/888,202

(22) PCT Filed: Apr. 7, 2014
(86) PCT No.: PCT/US14/33198

§ 371 Date: Oct. 30, 2015

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

A system and method applies physics modeling and 3D printing to design and fabricate customized wellbore logging tools for operation in specific wells or sets of wells.

### FIELD OF THE DISCLOSURE

The present disclosure relates generally to downhole tool design and more specifically, to a method of logging tool design customization and fabrication using three-dimensional (“3D”) printers and physics modeling.

### BACKGROUND

Conventional techniques to design and manufacture downhole logging tools apply a “one-size-fits-all” approach. In other words, such conventional logging tools are designed to work in all possible environments with minimal to no design or manufacturing changes. Moreover, the design of the tools is performed in research and development facilities, while the manufacturing is performed in manufacturing centers—both of which are typically logistically far from the location in which the tools are run, usually resulting in unproductive downtime.

### BRIEF DESCRIPTION OF THE DRAWINGS

FIG. 1 is a block diagram of a downhole tool design system according to certain exemplary embodiments of the present disclosure;

FIG. 2A is flow chart of a method utilized to fabricate a wellbore logging tool, according to certain illustrative methods of the present disclosure;

FIG. 2B illustrates a logging tool fabricated using the method of FIG. 2A, the tool being deployed along a wellbore; and

FIG. 3 illustrates a method utilized by a tool design system to optimize a tool design, according to an alternative illustrative method of the present disclosure.

### DESCRIPTION OF ILLUSTRATIVE EMBODIMENTS

Illustrative embodiments and related methods of the present disclosure are described below as they might be employed in system which designs and fabricates logging tools using 3D printers and physics modeling. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of this disclosure will become apparent from consideration of the following description and drawings.

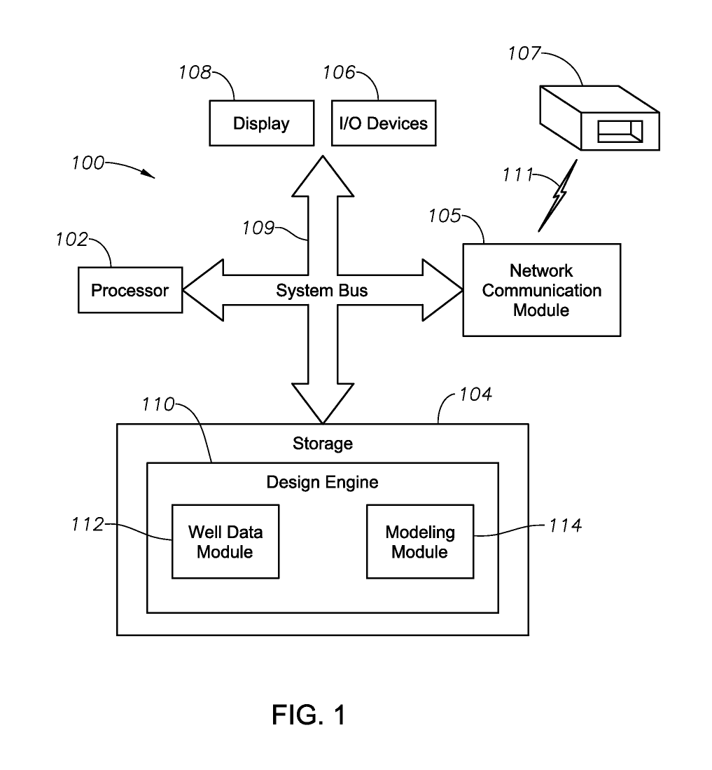

FIG. 1 is a block diagram of a downhole tool design system 100 according to certain exemplary embodiments of the present disclosure. As will be described herein, exemplary embodiments of the present disclosure apply physics modeling and 3D printing to thereby customize wellbore logging tools for operation in specific environments. In an illustrative generalized method, first an estimation or measurement of the target environment (subterranean formation, for example) is made using alternative methods. Then, based on the characteristics of the wellbore, an optimized tool design is determined. Finally, a logging tool based upon the design is fabricated using a 3D printer.

Various components of the logging tool may be optimized using illustrative embodiments of the present disclosure. For example, first, the cross-section of the tool sensor housing may be selected to fit the borehole cross section. Second, the size, geometry, spacing or count of the tool sensor instrument aperture (electrode or antenna) may be selected to achieve ideal signal delivery, power consumption, depth of investigation, or vertical resolution. Third, the acoustic tool insulator section designed to reduce the direct coupling between an acoustic transmitter and receiver in a particular well. Fourth, the thickness of sleeves or wires may be selected for ideal-off between protection, packaging and sensing performance. Fifth, single-use tool parts, specifically designed for a certain well, may be designed.

Sixth, for example, the size of mechanical and/or electrical components may be selected for operation in different borehole sizes and temperature ranges. Seventh, logging tool components may be fabricated which exactly match the measured or expected geometry of the borehole, casing, joints, or other man-made structures downhole. Moreover, embodiments of the present disclosure may be coupled with borehole imaging techniques such as resistivity, acoustic, or 3D image reconstruction from multiple 2D borehole images received from borehole cameras in order to obtain more complete information about the borehole that can assist in the optimization process. These and other advantages of the present disclosure will be apparent to those ordinarily skilled in the art having the benefit of this disclosure. Accordingly, the methods taught herein are useful to customize and fabricate logging tools for specific downhole environments.

Referring to FIG. 1, exemplary downhole tool design system 100 includes at least one processor 102, a non-transitory, computer-readable storage 104, transceiver/network communication module 105, optional I/O devices 106, and an optional display 108 (e.g., user interface), all interconnected via a system bus 109. Communication module 105 allows communication with 3D printer 107 via wired or wireless link 111. Software instructions executable by the processor 102 for implementing software instructions stored within design engine 110 in accordance with the exemplary embodiments described herein, may be stored in storage 104 or some other computer-readable medium. Although not explicitly shown in FIG. 1, it will be recognized that downhole tool design system 100 may be connected to one or more public and/or private networks via one or more appropriate network connections. It will also be recognized that the software instructions embodying design engine 110 may also be loaded into storage 104 from a CD-ROM or other appropriate storage media via wired or wireless methods.

Moreover, those ordinarily skilled in the art will appreciate that embodiments of this disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. This disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof in a computer system or other processing system.

Still referring to FIG. 1, in certain exemplary embodiments, design engine 110 includes well data module 112 and modeling module 114. Well data module 112 provides real-time robust data capture, storage, retrieval and integration of wellbore characteristic and subterranean formation data. In other embodiments, well data module 112 may also process other reservoir related data that spans across all aspects of the well planning, construction and completion processes such as, for example, drilling, cementing, wireline logging, well testing and stimulation. Such data includes, for example, calibrated data received from wellbore logging sensors, as well as data representing various petrophysical properties and wellbore fluid properties. Moreover, such data may include, for example, logging data from downhole or surface logging tools, such as resistivity, acoustic, NMR logging tools and fluid sampling and testing devices. In alternative embodiments, the data may also be obtained from laboratory or downhole analysis of cores. Data obtained from offset wells can also be used by extrapolating it to the location of the present wellbore. In yet other illustrative embodiments, surface or downhole seismic imaging can also be used.

The database (not shown) which stores this data may reside within well data module 112 or at a remote location. An exemplary database platform is, for example, the OpenWells® software suite, commercially offered through Landmark Graphics Corporation of Houston Tex. Additionally, well monitoring capability and data integration may be provided by a platform such as, for example, the MaxActivity™ rig floor monitoring software, commercially available through Halliburton Energy Services Co. of Houston, Tex. Those ordinarily skilled in the art having the benefit of this disclosure realize there are a variety of software platforms and associated systems to retrieve, store and integrate the well related data, as described herein.

Still referring to the exemplary embodiment of FIG. 1, design engine 110 also includes modeling module 114 that provides physics and earth modeling of the wellbore and logging tools, as will be described below. The earth modeling capabilities of modeling module 114 provides, for example, logging planning features and subsurface stratigraphic visualization including, for example, geo science interpretation, petroleum system modeling, geochemical analysis, stratigraphic gridding, facies and petrophysical and wellbore fluid property modeling. In addition, modeling module 114 models well paths, as well as cross-sectional through the facies and porosity data. Exemplary earth modeling platforms include DecisionSpace®, commercially available through the Assignee of the present invention, Landmark Graphics Corporation of Houston, Tex. However, those ordinarily skilled in the art having the benefit of this disclosure realize a variety of other earth modeling platforms may also be utilized with the present invention.

Additionally, modeling module 114 also models the performance and sensitivity of the logging tools (i.e., tool physics) along the simulated wellbore. In certain illustrative embodiments, a model of logging tools is run to estimate the performance of the tools using wellbore characteristics that include, for example, resistivities, compressional/shear/Stoneley wave speeds, porosities, densities, or water saturations. Such modeling may include, for example, electromagnetic (“EM”) modeling, acoustic modeling, seismic modeling, nuclear magnetic resonance (“NMR”) modeling, or neutron/photon transport modeling via one of the available numerical methods which may include, for example, finite difference, finite elements, method of moments, integral equations, semi-analytic formation, ray-tracing, or Monte Carlo simulations. These methods may be implemented via algorithms that are written in one of the many available programming languages and executed in one of the available operating systems that run on micro-processors or micro-controllers, as will be understood by those ordinarily skilled in the art having the benefit of this disclosure.

Ultimately, as will be described in more detail below, the physics modeling of the tool is used to evaluate its performance and sensitivity for a given wellbore having certain characteristics. Changes to the logging tool design may then be performed by tool design system 100 as necessary in order to thereby maximize the performance and sensitivity until an optimized design is determined. Thereafter, tool design system 100 utilizes 3D printer 107 to fabricate the logging tool and/or logging tool component using the optimized design.

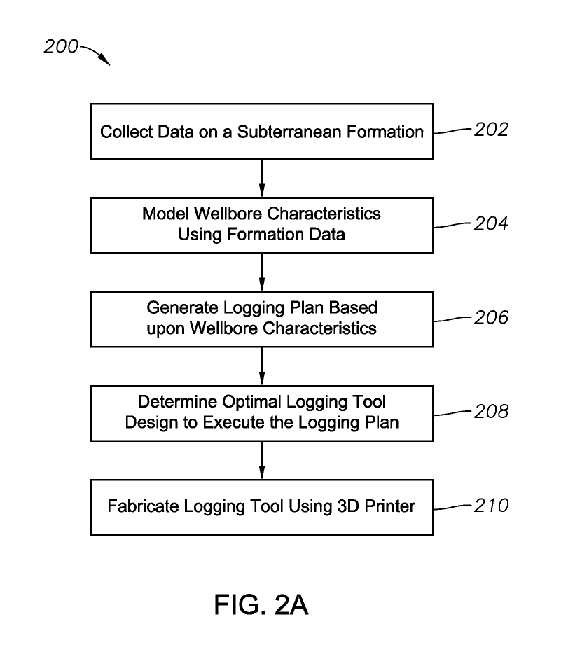

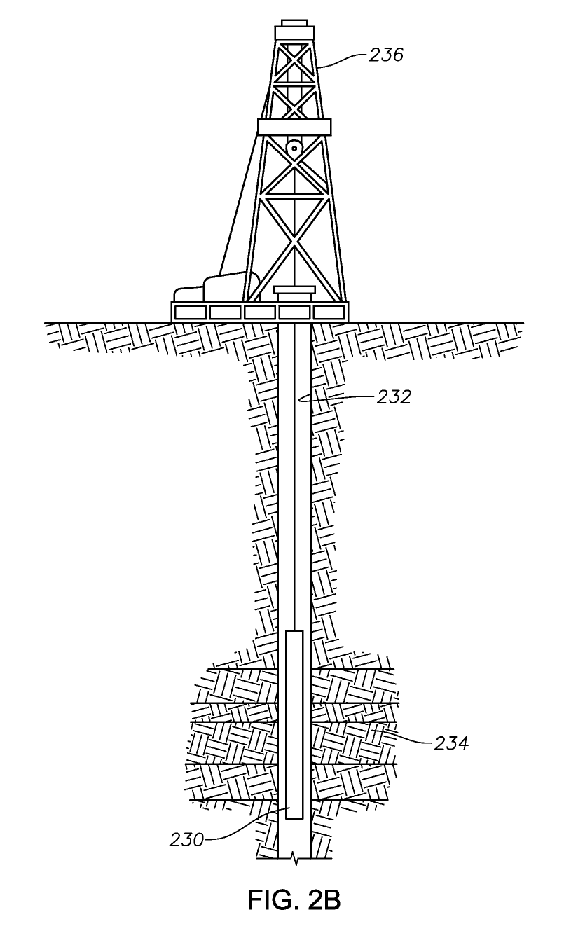

FIG. 2A is flow chart of a method 200 utilized to fabricate a wellbore logging tool, according to certain illustrative methods of the present disclosure. FIG. 2B illustrates a logging tool fabricated using method 200, the tool being deployed along a wellbore. In the simplified illustration of FIG. 2B, a wireline logging tool 230 has been deployed down a wellbore 232 extending through a subterranean formation 234 which includes one or more hydrocarbon reservoirs. A derrick 236 is positioned above wellbore 232 to conduct various logging and other hydrocarbon related operations, as understood in the art. Although illustrated as a wireline logging tool, logging tool 230 may be any variety of tools, such as, for example, a tool utilized in a measurement-while-drilling (“MWD”) or logging-while-drilling (“LWD”) application.

With reference to FIGS. 1, 2A and 2B, at block 202, wellbore tool design system 100 collects data on subterranean formation 234. In certain embodiments, the data may be retrieved from subterranean formation 234 itself, the surface, or other wells. For example, the subterranean formation data may include logging data from downhole or surface logging tools, such as resistivity, acoustic, NMR logging tools, as well as wellbore fluid sampling and testing devices. Alternatively, the subterranean formation data may also be obtained from laboratory or downhole analysis of cores. Moreover, the data may be obtained from offset wells where it is used to extrapolate to the location of the present well. Also, surface or downhole seismic imaging data can also be used. Processor 102 may store and retrieve such data from well data module 112, or the data may be communicated directly to design engine 110 from some external source.

In this example, however, at block 204, wellbore tool design system 100 models the characteristics of wellbore 232 using the subterranean formation data. Here, wellbore tool design system 100 utilizes the subterranean formation data to determine the wellbore characteristics. Such wellbore characteristics may include, for example, survey data (e.g., inclination, azimuth);

electrical or mechanical properties of wellbore fluid (e.g., mud resistivity, density, viscosity); properties of the invaded zones, such as radial depth of invasion, resistivity or acoustic wave speed distribution of invasion, locations of the invaded zones; petrophysical property data, such as flushed zone resistivity, water saturation, shale volume, sand volume, porosity, mobility and volume of hydrocarbons; or virgin zone information, such as true resistivity.

Wellbore tool design system 100 then performs statistical calculations of the wellbore characteristics to determine, for example, the mean or variance of the data after the statistical distribution of the modeled wellbore characteristics has been determined. Any variety of statistical methods may be utilized, such as, for example, mean calculation, variance calculation, histogram calculation, cross-correlation calculation, or calculation of percentage upper limits (i.e., parameter value below which a given percentage of samples can be observed, etc).

This statistical calculation results in a range of wellbore characteristic values that are then used to determine reservoir volume, location and mobility for subterranean formation 234. At block 206, tool design system 100 generates a logging plan to be used along subterranean formation 234 based upon the range of wellbore characteristic values. A logging plan is comprised of wellbore characteristic value ranges that are of particular importance for formation evaluation purposes. In certain embodiments, the range of values that is included in the logging plan may be smaller than the ranges that are observed in the wellbore characteristics because not all depth ranges may be of interest. For example, values from depth ranges that potentially contain hydrocarbons may be emphasized, while others may be discarded. The logging plan is also comprised of information that is related to the combination of measurements that should be taken on the same logging string and the temporal order of logging runs. The logging plan may also include information about the logging string configuration, i.e. the spatial order of measurement devices in the hole. In yet other embodiments, the logging plan is also made in light of other information that is available, such as, for example, borehole condition, mud resistivity, seismic information about geology and cost of measurements. For example, certain measurement value ranges could be discarded if borehole conditions or mud resistivity does not allow an accurate measurement. Similarly, certain measurements could be discarded because of the cost (in terms of resources and time) associated with making them.

Therefore, still referring to block 206, the logging plan will include ranges of logging tool measurement values that correspond to the ranges of wellbore characteristic values. Ranges of wellbore characteristics may include values corresponding to, for example, a range of resistivities, range of compressional/shear/Stoneley wave speeds, range of porosity, range of densities, range of water saturation that are observed or modeled in the well zones of interest. The range of logging tool measurement utilized by tool design system 100 will be those measurements which result in highest quality measurements that are as close as possible to real wellbore characteristics. Such measurements will reflect data that is least affected by adverse logging environments; therefore, the corresponding ranges of logging tool measurements will reflect the tool design which will be least affected by the environment.

In those embodiments utilizing histogram calculations, the statistical calculation is performed by first taking a histogram of all measurements in zones of interest, and defining the range between 10% and 90% points of the histogram. The histogram is then taken by determining certain bins based on values of a parameter of interest and counting the number of samples that are in each bin. 10% point of the histogram is the parameter of interest value below which 10% of all samples are observed. Similarly, 90% point of the histogram is the parameter of interest value below which 90% of all samples are observed. These 10% and 90% points constitute practical minimum and maximum limits to the range of parameter that is observed in the data. Ultimately, in certain embodiments, the range of resistivity obtained in this manner can be used to optimize tool parameters for the resistivity tool, while range of densities obtained in this manner can be used to optimize a density tool design.

At block 208, using the selected range of logging tool measurement values, tool design system 100 determines the optimal logging tool design in which to execute the logging plan. In this illustrative embodiment, the optimal mechanical, electrical and/or software configuration of a logging tool or component is determined by considering the range of measurements identified at block 206. In general, the optimum parameter (for example frequency) can be estimated by simulating the measurements including realistic environmental and instrument noise effects, and picking the parameter that produces the least difference between the measurement and real wellbore characteristics. For example, in induction resistivity tools, a high resistivity range requires high frequencies to be used since they are better tuned to detect the small signals of high resistivity formations. On the other hand, a low resistivity range requires low frequencies to be used since they suffer less saturation of phase signal.

Illustrative optimized mechanical configurations which may be optimized include, for example, optimization of: the size or shape of the sensor housing to fit the borehole in the zone of interest; size of the inner parts of the tool to have the mechanical integrity and electronics isolation required with the smallest tool size possible for logging in smaller borehole sizes or at different temperature ranges; or sensor aperture size, geometry, spacing, or count to achieve ideal signal delivery, power consumption, depth of investigation, or vertical resolution. Here, for example, in an induction type tool, spacing between the transmitters and receivers can be increased to increase the depth of investigation. In a Laterolog tool, size and arrangement of electrodes can be modified to achieve better focusing for operating in an environment with higher formation-mud contrast. In an acoustic tool, size of the insulator section can be modified to optimally reject waves at certain speeds. Moreover, the thickness of sleeves or other parts may be reduced to minimize tool size.

Thereafter, at block 210, processor 102 then instructs 3D printer 107 to fabricate the logging tool or component in accordance with the logging tool design. 3D printer 107 then fabricates the logging tool 230, for example, and it is thereafter deployed down wellbore 232 as shown in FIG. 2B.

In certain other illustrative methods, after the optimized logging tool or component has been fabricated, it may then be utilized to obtain further wellbore characteristic data or performance and sensitivity data while it is positioned along wellbore 232. Although not shown, logging tool 232 will include the necessary telemetry circuitry to communicate the performance or sensitivity data back to the surface, where the data may then be reevaluated by design system 100 at block 204. Once reevaluated, method 200 then continues whereby a more optimized logging tool may be fabricated based upon the real-time wellbore characteristic and logging tool performance/sensitivity data.

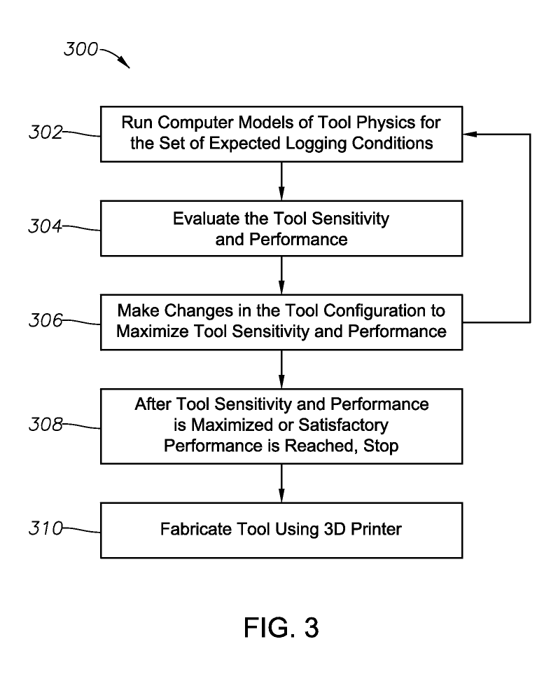

FIG. 3 illustrates a method 300 utilized by tool design system 100 at block 208 (FIG. 2A) to optimize the tool design, according to an alternative illustrative method of the present disclosure. At block 302, tool design system 100, via modeling module 114, generates a computer model of the logging tool and tool physics (i.e., first design) for the expected logging plan to thereby determine the performance of the tool using the range of measurement values identified in block 204 above. Such modeling may include, for example, EM modeling, acoustic modeling, seismic modeling, NMR modeling, or neutron/photon transport modeling via one of the numerical methods which may include finite difference, finite elements, method of moments, integral equations, semi-analytic formation, ray-tracing, or Monte Carlo simulations. In one illustrative method, the modeling is run for a representative set of cases that cover the whole range of wellbore characteristics identified in block 204 above. Note that each wellbore characteristic (e.g., wellbore fluid or pressure) is usually associated with one type of logging tool measurement and one type of tool, so modeling needs to be performed only for the characteristic ranges that are associated with each type of tool. For example, tool design system 100 conducts modeling of the resistivity tool to cover the range of resistivity, white modeling of an acoustic tool is conducted to cover a range of shear velocities.

At block 304, tool design system 100 then evaluates the sensitivity and performance of the modeled logging tool having the first design. For example, the effects on logging tool range of measurement values caused by wellbore fluids or pressures are evaluated. The modeling may be conducted using the first design to thereby obtain tool sensitivity and performance for the ranges of logging tool measurement values. Thereafter, changes may be made to the tool configuration (i.e., first design) to further improve and/or maximize tool sensitivity and performance in comparison to the first design, thus generating a second design in block 306. Thereafter, the algorithm then reverts back to blocks 302 and 304 where a computer model of the second design is then generated and analyzed. This iterative process may continue until the tool's sensitivity and performance are maximized (i.e., modeled measurements match real wellbore characteristics as close as possible) or satisfactory performance has been reached at block 308. Thereafter, the maximized second tool design is then communicated to 3D printer 107, where the tool or component is fabricated at block 310.

In certain other illustrative methods of the present disclosure, 3D printing can be accomplished using existing parts of logging tools which may or may not have been already used, as well as the new molds. In one such embodiment, existing tool components may be modified using the logging plan of methods 200 or 300, or to accommodate new changes in wellbore characteristics. For example, portions of an existing component can be removed by using a 3D printer or another automated manufacturing device that has programmed operation to reduce the size of the component, or to create a completely different component from it. In other methods, a component for a larger borehole size can be made smaller to accommodate a smaller borehole size.

In yet other illustrative methods, 3D printing can also be used in conjunction with construction of PCB boards. In one example, a new PCB layout can be designed manually or with automated software to fit the mechanical requirements of the packaging or insulation of the logging tool. Thereafter, the printing process of the new board is fully streamlined. In yet other methods, modification or partial/full construction of PCB boards may be conducted by tool design system 100, which can extend optimization to electrical components in a streamlined way.

In further methods of the present disclosure, tool design system 100 may fabricate single-use tool components. In such an application, tool components can be constructed differently in order to optimize each run. Here, for example, different components can be used in different runs of the same wellbore to obtain data that can ideally cover the whole range of wellbore characteristics, identified in block 204, when combined.

In yet another illustrative method, another application of tool design system 100 is to perform customization with 3D printers is to first make a 3D image of the geometry of man-made structures such as the borehole, pipes, pipe joints, in or out of the wellbore and formation, and use the 3D image to construct components that are a custom fit for the imaged geometry. The custom fit is obtained by re-designing to components with a new size requirement that is obtained from a geometric analysis of the 3D images. For example, 3D image may be of a borehole and a minimum diameter of the borehole may be obtained from the 3D image. The minimum diameter may be used to design the thickness of the packaging of a tool. For example, arms of the calipers, antenna cavities, pads of imaging tools and shapes of packers can be optimized to operate at certain depths in the wellbore.

In yet other embodiments, wellbore characteristic data utilized to determine the tool design may be obtained from a plurality of wellbores. Accordingly, the resulting tool design will be customized for use in the plurality of wells.

Accordingly, the present disclosure provides systems and methods by which to fabricate customized logging tools virtually anywhere. For example, if a system of the present disclosure were located at a well site, real-time wellbore characteristic data may be obtained from the well and used to fabricate a customized tool immediately at the site. Thus, the downtime associated with ordering the tool from a remote fabrication facility, and shipping the tool to the well site, would be avoided. In yet other embodiments, the tool design system may fabricate the tool or component in the same district location, geological location or geopolitical location in which the wellbore characteristic data is acquired.

Moreover, the foregoing methods and systems described herein provide customization of logging tools/components beyond the conventional “one-size-fits-all” approach. Through use of the disclosed embodiments, customized logging tools/components may be custom designed and manufactured for a particular well or set of wells to optimally perform in logging or other operations.

The exemplary embodiments described herein further relate to any one or more of the following paragraphs:
1. A method to fabricate a wellbore logging tool, the method comprising collecting data on a subterranean formation; utilizing the data to model characteristics of a wellbore positioned along the subterranean formation; utilizing the wellbore characteristics to determine a logging plan to be used along the subterranean formation; determining a logging tool design to execute the logging plan; and utilizing a three-dimensional printer to fabricate at least one component of a logging tool in accordance with the logging tool design.
2. A method as defined in paragraph 1, wherein determining the logging tool design comprises modeling a logging tool positioned along the wellbore, the logging tool having a first design configured to execute the logging plan; evaluating a performance of the logging tool; and altering the first design to thereby generate a second design which improves the performance of the logging tool in comparison to the first design, wherein the second design is selected as the logging tool design.
3. A computer-implemented method as defined in paragraphs 1 or 2, wherein evaluating the performance of the logging tool comprises modeling effects on logging tool measurements caused by wellbore fluid or pressure.
4. A computer-implemented method as defined in any of paragraphs 1-3, wherein the logging tool design which maximizes the performance of the logging tool is a size of a sensor housing to fit the wellbore.
5. A computer-implemented method as defined in any of paragraphs 1-4, wherein the logging tool design which maximizes the performance of the logging tool is a size, geometry, spacing or count of sensor apertures necessary to achieve ideal signal delivery, power consumption, depth of investigation or vertical resolution.
6. A computer-implemented method as defined in any of paragraphs 1-5, wherein the logging tool design which maximizes the performance of the logging tool is an acoustic tool insulator section design that reduces direct coupling between an acoustic transmitter and an acoustic receiver in the wellbore.
7. A computer-implemented method as defined in any of paragraphs 1-6, wherein the logging tool design which maximizes the performance of the logging tool is a logging tool component size which matches a measured or expected geometry of the wellbore, casing, or joints.
8. A computer-implemented method as defined in any of paragraphs 1-7, wherein the wellbore characteristics comprise data related to wellbore fluid properties or petrophysical properties.
9. A computer-implemented method as defined in any of paragraphs 1-8, wherein determining the logging plan comprises determining a range of measurements that correspond to the wellbore characteristics.
10. A computer-implemented method as defined in any of paragraphs 1-9, wherein the range of measurements comprise ranges of resistivities, densities, porosities, or water saturations.
11. A computer-implemented method as defined in any of paragraphs 1-10, wherein determining the logging tool design comprises modeling the logging tool positioned along the wellbore, the logging tool having a first design configured to execute the logging plan; determining a range of measurements that correspond to the wellbore characteristics; evaluating the range of measurements to determine a performance of the logging tool; and altering the first design to thereby generate a second design which maximizes the performance of the logging tool, wherein the second design is selected as the logging tool design.
12. A computer-implemented method as defined in any of paragraphs 1-11, wherein fabricating the component of the logging tool comprises utilizing the three-dimensional printer to alter an existing component in accordance with the logging tool design.
13. A computer-implemented method as defined in any of paragraphs 1-12, wherein the component is at least one of a circuit board, antenna, antenna aperture, antenna cavity, electrode, caliper arm or imaging tool pad.
14. A method to fabricate a downhole tool, comprising modeling a wellbore positioned along a subterranean formation; determining a downhole tool design that is at least partially customized for the modeled wellbore; and utilizing a three-dimensional printer to fabricate at least one component of a downhole tool in accordance with the tool design.
15. A method as defined in paragraph 14, wherein fabricating the component comprises altering an existing component in accordance with the tool design.
16. A method as defined in paragraphs 14 or 15, wherein fabrication of the component is performed at a same well, district, geological or geopolitical location in which data utilized to model the wellbore is acquired.
17. A method as defined in any of paragraphs 14-16, wherein modeling the wellbore comprises modeling a plurality of wellbores, the tool design being customized for the plurality of wellbores.
18. A method as defined in any of paragraphs 14-17, wherein the downhole tool is a logging tool or a drilling tool.
19. A method as defined in any of paragraphs 14-18, wherein determining the tool design comprises determining a first design; analyzing a performance of the first design along the wellbore; and altering the first design to a second design which maximizes performance of downhole tool, wherein the second design is the tool design.
20. A method as defined in any of paragraphs 14-19, wherein a single-use component is fabricated.
21. A computer-implemented method to fabricate a downhole tool, the method comprising generating a three-dimensional (“3D”) image of a man-made structure; and utilizing a geometry of the 3D image to fabricate downhole tool components that are customized for the man-made structure, the fabrication being performed using a 3D printer.
22. A computer-implemented method as defined in paragraph 21, wherein the man-made structure is a borehole or pipe; and the downhole tool component is a caliper arm, imaging tool pad or packer.

Furthermore, the exemplary methods described herein may be implemented by a system including processing circuitry or a computer program product including instructions which, when executed by at least one processor, causes the processor to perform any of the method described herein.

Although various embodiments and methods have been shown and described, the present disclosure is not limited to such embodiments and methods and will be understood to include all modifications and variations as would be apparent to one skilled in the art. For example, in addition to logging tools, embodiments of the present disclosure may be utilized to design other downhole tools, including, for example, drilling tools or other downhole components or tools. Therefore, it should be understood that this disclosure is not intended to be limited to the particular forms disclosed. Rather, the intention is to cover all modifications, equivalents and alternatives falling within the spirit and scope of the disclosure as defined by the appended claims.

1. A method to fabricate a wellbore logging tool, the method comprising:
collecting data on a subterranean formation;
utilizing the data to model characteristics of a wellbore positioned along the subterranean formation;
utilizing the wellbore characteristics to determine a logging plan to be used along the subterranean formation;
determining a logging tool design to execute the logging plan; and
utilizing a three-dimensional printer to fabricate at least one component of a logging tool in accordance with the logging tool design.

2. A method as defined in claim 1, wherein determining the logging tool design comprises:
modeling a logging tool positioned along the wellbore, the logging tool having a first design configured to execute the logging plan;
evaluating a performance of the logging tool; and
altering the first design to thereby generate a second design which improves the performance of the logging tool in comparison to the first design, wherein the second design is selected as the logging tool design.

3. A computer-implemented method as defined in claim 2, wherein evaluating the performance of the logging tool comprises modeling effects on logging tool measurements caused by wellbore fluid or pressure.

4. A computer-implemented method as defined in claim 2, wherein the logging tool design which maximizes the performance of the logging tool is a size of a sensor housing to fit the wellbore.

5. A computer-implemented method as defined in claim 2, wherein the logging tool design which maximizes the performance of the logging tool is a size, geometry, spacing or count of sensor apertures necessary to achieve ideal signal delivery, power consumption, depth of investigation or vertical resolution.

6. A computer-implemented method as defined in claim 2, wherein the logging tool design which maximizes the performance of the logging tool is an acoustic tool insulator section design that reduces direct coupling between an acoustic transmitter and an acoustic receiver in the wellbore.

7. A computer-implemented method as defined in claim 2, wherein the logging tool design which maximizes the performance of the logging tool is a logging tool component size which matches a measured or expected geometry of the wellbore, casing, or joints.

8. A computer-implemented method as defined in claim 1, wherein the wellbore characteristics comprise data related to wellbore fluid properties or petrophysical properties.

9. A computer-implemented method as defined in claim 8, wherein determining the logging plan comprises determining a range of measurements that correspond to the wellbore characteristics.

10. A computer-implemented method as defined in claim 9, wherein the range of measurements comprise ranges of resistivities, densities, porosities, or water saturations.

11. A computer-implemented method as defined in claim 1, wherein determining the logging tool design comprises:
modeling the logging tool positioned along the wellbore, the logging tool having a first design configured to execute the logging plan;
determining a range of measurements that correspond to the wellbore characteristics;
evaluating the range of measurements to determine a performance of the logging tool; and
altering the first design to thereby generate a second design which maximizes the performance of the logging tool, wherein the second design is selected as the logging tool design.

12. A computer-implemented method as defined in claim 1, wherein fabricating the component of the logging tool comprises utilizing the three-dimensional printer to alter an existing component in accordance with the logging tool design.

13. A computer-implemented method as defined in claim 1, wherein the component is at least one of a circuit board, antenna, antenna aperture, antenna cavity, electrode, caliper arm or imaging tool pad.

14. A method to fabricate a downhole tool, comprising:
modeling a wellbore positioned along a subterranean formation;
determining a downhole tool design that is at least partially customized for the modeled wellbore; and
utilizing a three-dimensional printer to fabricate at least one component of a downhole tool in accordance with the tool design.

15. A method as defined in claim 14, wherein fabricating the component comprises altering an existing component in accordance with the tool design.

16. A method as defined in claim 15, wherein fabrication of the component is performed at a same well, district, geological or geopolitical location in which data utilized to model the wellbore is acquired.

17. A method as defined in claim 14, wherein modeling the wellbore comprises modeling a plurality of wellbores, the tool design being customized for the plurality of wellbores.

18. A method as defined in claim 14, wherein the downhole tool is a logging tool or a drilling tool.

19. A method as defined in claim 14, wherein determining the tool design comprises:
determining a first design;
analyzing a performance of the first design along the wellbore; and
altering the first design to a second design which maximizes performance of downhole tool, wherein the second design is the tool design.

20. A method as defined in claim 14, wherein a single-use component is fabricated.

21. A computer-implemented method to fabricate a downhole tool, the method comprising:
generating a three-dimensional (“3D”) image of a man-made structure; and
utilizing a geometry of the 3D image to fabricate downhole tool components that are customized for the man-made structure, the fabrication being performed using a 3D printer.

22. A computer-implemented method as defined in claim 21, wherein:
the man-made structure is a borehole or pipe; and
the downhole tool component is a caliper arm, imaging tool pad or packer.

23. A system comprising processing circuitry to implement the method of claim 1.
